(19) United States
(12) Patent Application Publication
(10) Pub. No.: US 2012/0137906 A1
(43) Pub. Date: Jun. 7, 2012

(54) COLOR PRINT MODULE FOR A FRANKING MACHINE

(75) Inventor: Romain PILLARD, CHARTRETTES (FR)

(73) Assignee: NEOPOST TECHNOLOGIES, BAGNEUX (FR)

(21) Appl. No.: 13/310,942

(22) Filed: Dec. 5, 2011

(30) Foreign Application Priority Data
Dec. 6, 2010 (EP) 10306357.4

(51) Int. Cl. B41F 3/44; B41M 1/14

(52) U.S. Cl. 101/186; 101/211

(57) ABSTRACT

A color printing method for a franking system making it possible to print a franking mark on a mailpiece using at least three primary inks, namely cyan, magenta, and yellow, wherein at least one of said primary inks, namely cyan or magenta, is constituted by a similar postal ink, namely postal blue for cyan and/or postal red for magenta.

### FIELD OF THE INVENTION

The present invention relates to the field of mail-handling, and in particular to the field of franking machines or “postage meters”, or of other envelope printers, each of which includes an inkjet digital print module.

### PRIOR ART

Nowadays, inkjet printing is in very widespread use for printing photographs, and office documents, but, over the last ten years or so, it has also been used in the postal field for printing franking or “postage” marks. For such postal use, printing is then monochrome only, and of a specific color or “postal color” that varies depending on the country of franking (fluorescent red for the USA and Canada, 185U red in Great Britain, and postal blue for Germany and France, for example), and printing is then both of the franking mark proper and of any logos, adverts, images, or messages that might accompany it.

If the sender then wishes the graphical elements other than the franking mark not to be printed in the same color as the postal ink, but more conventionally with black ink, it is necessary to provide the franking machine with an additional print head fed from a black ink reservoir in addition to the print head fed with the postal color ink, as illustrated, for example by Patent U.S. Pat. No. 6,079,327.

However, certain senders/users wish such logos, adverts, images, or messages to be printed not only in monochrome manner but also in color so as to attract the attention of the recipient or merely so as to convey the image of their company. In order to satisfy this need, the franking machine must thus be capable of accommodating both of those printing constraints (postal printing and color printing).

Conventionally, the printing methods implemented in a color printer use the primary inks cyan (C), magenta (M), and yellow (Y), to which black (K) is added in order to reinforce the contrast of the colors. In an inkjet printer, those colors are added together to create other colors present in the gamut. By acting on the combination of these four primary inks and on their percentages, it is possible to obtain all of the colors printable within a certain color gamut volume. Certain higher-performance printers used for high-quality photographic printing use up to eight different primary inks (cyan, light cyan, magenta, light magenta, yellow, light yellow, mat black, and glossy black). This makes it possible to extend the gamut and to print colors that cannot be obtained with only four primary inks.

Unfortunately, franking marks must comply with postal specifications such as those defined, for example, in Universal Postal Union (UPU) Standard S44, in particular in terms of contrast and of modulation for reading bar codes and, in practice, it is very difficult to obtain satisfactory franking marks beyond a certain printing speed that is typically 1 meter per second (m/s) with a combination of inks. The positioning errors in the ink droplets coming from different heads perturb reading bar codes, even when such errors are hardly discernable with the naked eye. This also applies with three-color or four-color integrated print heads having rows of nozzles, each of which corresponds to one of the primary inks, such as those used in office inkjet printers.

In addition, even with such an extended gamut of colors, it is not possible to obtain the fluorescent red necessary for printing franking marks in the USA or in Canada. That is why the Applicant has, in Application U.S. 2006/023023, proposed a structure having a plurality of print heads making it possible to print postal franking in color at high printing speeds, and in which structure the postal ink necessary for printing the franking mark is associated with the conventional three or four primary inks necessary for performing the desired color printing for the other graphical elements.

That solution was taken up by Pitney Bowes who, less than a year ago, put on the market a franking machine (Connect+™ 3000 model) that is capable not only of printing the franking mark in its specific postal color but also of associating therewith logos, advertising, images, and messages printed in four colors. To that end, that franking machine is provided with two print modules, one conventionally making it possible to print the franking mark in one color, and the other making it possible to print the other printed graphical elements in four colors.

The solution solves the problem posed, in particular as regards printing speed. Unfortunately, it is very costly due to adding the color print module in addition to the standard postal print module, and that addition also increases the overall length of the machine in which the module is incorporated and significantly alters its architecture.

### OBJECT AND DEFINITION OF THE INVENTION

An object of the present invention is therefore to propose a printing method for a color franking machine that is of cost comparable to the cost of a monochrome machine (i.e. a machine that only prints with one ink that is of postal color), without significantly reducing the printing speed. Another object of the invention is to propose a print module that can be mounted in franking machines having current architectures, without requiring significant alteration to its software configuration.

Another object of the invention is to propose a franking machine that uses the same set of primary inks and that can thus be used both in countries that require red postal ink and in countries that require blue postal ink.

These objects are achieved by a color printing method for a franking system making it possible to print a franking mark on a mailpiece using at least three primary inks, namely cyan, magenta, and yellow, wherein at least one of said primary inks, namely cyan or magenta, is constituted by a similar postal ink, namely postal blue for cyan and/or postal red for magenta. More particularly, in this method, said franking system includes a print module fed from three or four ink reservoirs, each of which contains an ink of a different color in order to perform three-color or four-color printing using a CMY model or a CMYK model, and in order to print said franking mark using a postal ink, the cyan ink reservoir is replaced with a reservoir of postal blue postal ink and/or the magenta ink reservoir is replaced with a reservoir of 185U red or fluorescent red postal ink.

Thus, it is possible, while preserving the original architecture of the franking machine, to print the franking mark and the graphical elements accompanying it using the same print module and without adversely affecting its printing speed.

In order to increase its contrast, said franking mark may be printed with a combination of postal ink and of black ink. In order to obtain, once printed, the color components required by postal specifications, said franking mark may be printed with a combination of postal ink and of at least one of the remaining inks.

Depending on the implementation, with said mailpiece also including graphical elements or elements identifying the sender or third parties, which elements are associated with said franking mark, said elements may be printed using a single ink other than the ink that enabled said franking mark to be printed, or in a color obtained from at least two inks.

The invention further provides a franking machine or an envelope printer including a print module fed from at least three ink reservoirs, each of which contains an ink of a different color, including at least one postal ink, said print module being suitable for implementing the above-mentioned color printing method based on postal ink.

### BRIEF DESCRIPTION OF THE DRAWINGS

Other characteristics and advantages of the present invention appear more clearly from the following description given by way of non-limiting indication, and with reference to the accompanying drawings, in which:

FIG. 1 is a fragmentary diagrammatic view of an inkjet franking machine with its print module of the invention; and

FIGS. 2 and 3 show different color gamuts obtained respectively with different inks or with different types of paper.

### DETAILED DESCRIPTION OF A PREFERRED IMPLEMENTATION

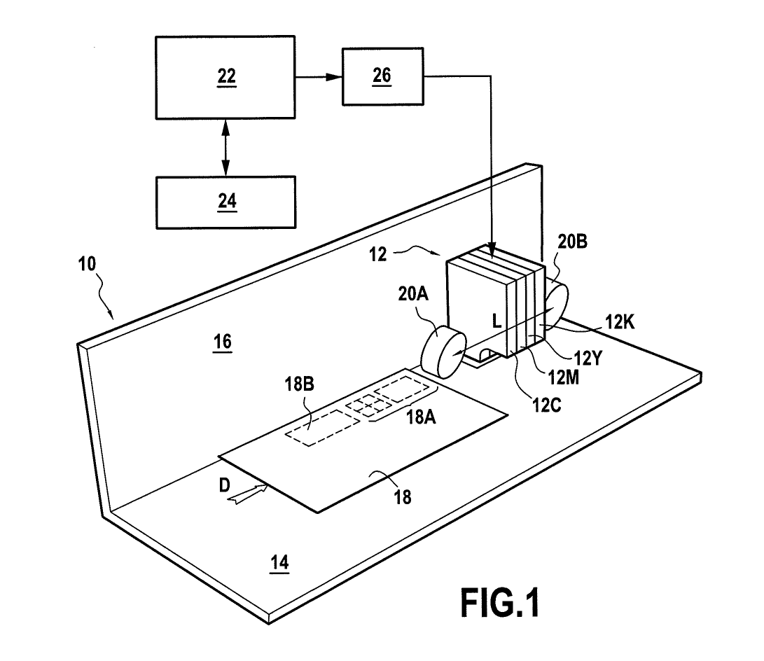

FIG. 1 is a fragmentary diagrammatic view of an inkjet franking machine 10 with its print head 12 overlying a guide plate 14 on which mailpieces 18 are conveyed in a longitudinal movement direction D and are jogged against a referencing wall 16. Said mailpieces are conveyed, as is known, by rollers (only the counter-rollers 20A, 20B are shown, which counter-rollers are disposed above the guide plate 14 immediately upstream and immediately downstream from the print head 12, and define between them a minimum printing length for printing the mailpieces) or by conveyor belts of the franking machine, in such a manner as to pass under the print head, thereby making it possible to print a postal imprint 18A on each of said mailpieces. Naturally, as in any franking machine, control circuits (not shown) are provided in its base so as to operate it and in particular so as to rotate the conveyor rollers depending on the positions of the mailpieces as they go through the machine as sensed by various sensors (not shown).

The print head 12 has four ink reservoirs 12C, 12M, 12Y, 12K, each of which is associated with means for ejecting the ink (conventionally one or two rows of inkjet nozzles) and is controlled by a set of electronic circuits conventionally comprising a microprocessor or microcontroller 22, a memory 24 and a driver circuit 26. The driver circuit controls the ink ejection nozzles of the print head under the control of the microprocessor and using a control program stored in the memory. The driver circuit may be incorporated in or separate from the print head, while the microprocessor and its memory are advantageously incorporated into the base of the franking machine to which the print head is connected, and of which they can constitute some of the control circuits.

In accordance with the invention, the ink of the reservoir 12C and the ink of the reservoir 12M that, for four-color printing using the CMYK model, respectively comprising a cyan ink and a magenta ink, are replaced with specific postal inks, namely postal blue instead of the cyan, and postal red, 185U red, or fluorescent red (depending on the country of installation of the machine) instead of the magenta. Thus, the width of the print module is not increased by the presence of a second head, and the printing speed, at least when only the franking mark is printed, is not reduced, said franking mark (and in particular its two-dimensional (2D) bar code) being printed with postal ink from the single row of nozzles associated with the reservoir filled with that ink, as in the prior art.

In addition, the use of such a standard four-color print head makes it possible to preserve a space of 125 mm that currently exists between the conveyor rollers flanking the print head in current print modules of franking machines, enabling postcard-format mailpieces to be printed, and thus avoiding any structural alteration of said modules. Using an additional module, as proposed in the prior art mentioned in the introduction, or merely using a single additional ink gives rise to a significant increase in the costs and in the overall size of the machine.

As regards the other graphical elements 18B, in particular for graphical elements identifying the sender (logos, advertising, and images, for example) or third-parties (messages making appeals for donations, for example) associated with the franking mark 18A, surprisingly the inventor has observed that replacing the two primary inks with the specific postal inks makes it possible to obtain rendering that is quite acceptable for the desired use, namely printing of mailpieces. This result is obtained without any color balancing. The following table compares the CIE LAB components of the colors obtained using illuminant D50, on flat-tint areas produced with primary inks of the cyan, magenta, yellow, and black (CMYK) model, and with the postal blue and fluorescent red postal inks.

| | component | | |
|---|---|---|---|
| Color | L | a* | b* |
| Cyan | 60 | −26 | −44 |
| Postal blue | 60 | −16 | −41 |
| Magenta | 56 | 61 | −1 |
| Fluorescent red | 64 | 51 | 18 |

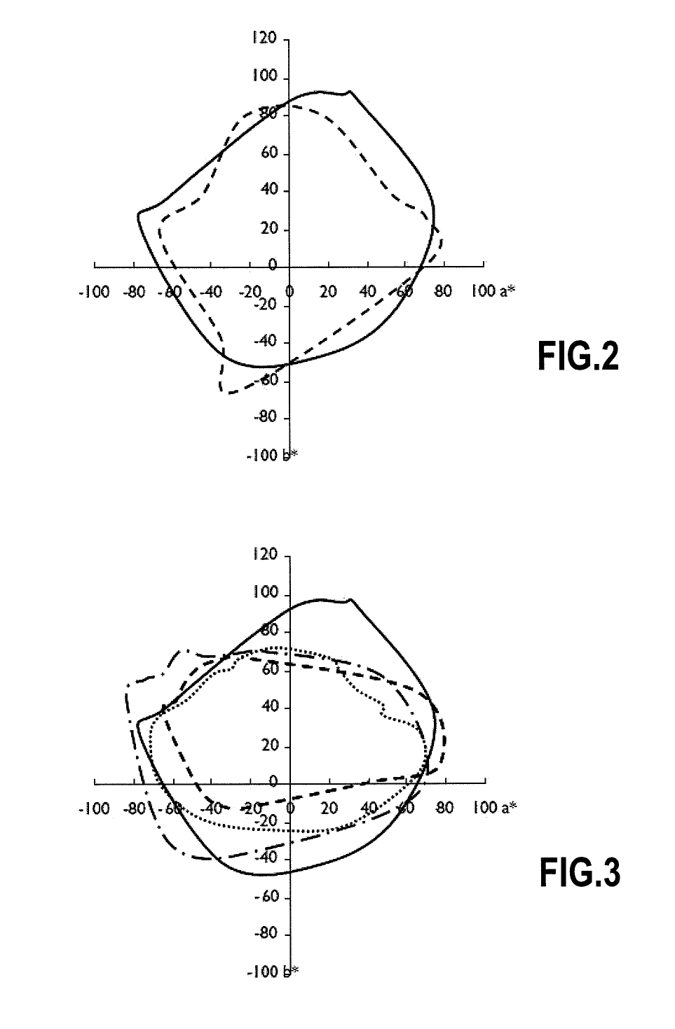

Although acceptable results are obtained without color balancing, the color control program stored in the memory 24 may be adapted to take account of the replacement of the primary inks, as shown in the example of FIG. 2 in which a first set of primary inks has been replaced with a second set of inks of similar colors.

The term “similar color” is used to mean a color having the same color base. Thus, cyan, which is also called “light blue” or “sky blue”, is similar to postal blue, which has the same blue base, and magenta, which is also called “fuchsia red” or “purplish red”, is similar to fluorescent red or to 185U red, both of which have the same red base.

FIG. 2 shows the color gamut obtained with the primary inks of the first set (in uninterrupted lines) and the color gamut obtained with the primary inks of the second set (in dashed lines), both gamuts being projected on the a*b* plane in the CIE LAB color space, which is a uniform color space representing all of the colors perceived by the standard human eye. It can be noted that the two curves are not superposed on each other, which indicates that certain colors that are printable with the first set cannot be printed with the second set.

In addition, without any color balancing, a color printed with the same proportions of primary inks is perceived differently with the first set or with the second set.

In order to obtain a reproduction of the colors that is close to the first set in the printable gamut, various methods can be applied. These well-known methods are not described in detail, and only their principle is recalled. Thus, the adjustment of the color profile consists in altering the proportions of primary inks of each color in order to obtain equivalent rendering. The clipping method consists in bringing the non-printable colors to the boundary of the curve corresponding to the second set. The compression method makes it possible to distribute the distortion caused by the differences in ink throughout the entire gamut, compression being used to compensate for major distortions while also complying with the perception of the differences in color.

It should be noted that the printing speed can vary depending on the quality that is expected for the graphical elements or identification elements to be printed. Thus, if only the postal ink is used, the speed does not differ at all from the speed of a conventional print module having postal ink only. The same applies if, in addition to the postal ink, the elements that are printed in addition to the franking mark require only the independent use (use without mixing) of one or more of the other three inks of the head (logo in yellow and message in black, for example), printing of the three colors (yellow, black, and postal blue, for example) then taking place at the same speed.

When an element to be printed requires the combination of at least two inks (e.g. logo in orange requiring the combination of red and of yellow), the printing speed may be kept constant if the quality that is obtained is sufficient, or reduced to obtain a better printing quality, and in particular better contrast. It should be noted that it is also possible to combine the postal ink and the black ink in order to increase the contrast of the bar codes included in the franking mark. This can be desirable on certain envelopes made of paper that is particularly porous. It is then possible to choose a high-speed printing mode or a reduced-speed printing mode as a function of the desired results.

In general, it is possible to combine the postal ink with one or more of the other primary inks so as to compensate for the defects related to the paper of the envelopes, in particular in order to obtain the color components required by postal specifications. As shown in FIG. 3, which shows the color gamuts obtained with the same set of primary inks on three different types of paper, as a function of the type of paper, the saturated colors can rapidly find themselves outside the capacities of the system. For improved rendering, adapted compensation for each type of paper is thus desirable by using various known compensation methods, including the above-mentioned methods.

It should also be noted that, although reference is made above to a print head in which the cyan and magenta inks are replaced with similar postal inks, naturally it is also possible for only one of those two inks to be replaced with a similar postal ink, the cyan being replaced with the postal blue or the magenta being replaced with the postal red, whether that postal red be fluorescent red or 185U red (this applies in particular when the machine is to be installed on a single type of market).

Finally, it should be noted that, although the above description refers to a four-color printing method and to four-color print modules for franking machines, the same principle of replacing a primary ink with a similar postal ink may apply to a three-color printing method and to three-color print modules using the CMY model, or indeed to print modules for envelope printers including, for example, more than four primary inks, as a function of the cost and of the overall size of the desired franking system.

What is claimed is:

1. A color printing method for a franking system making it possible to print a franking mark on a mailpiece using at least three primary inks, namely cyan, magenta, and yellow, wherein at least one of said primary inks, namely cyan or magenta, is constituted by a similar postal ink, namely postal blue for cyan and/or postal red for magenta.

2. A color printing method according to claim 1, wherein said franking system includes a print module fed from three or four ink reservoirs, each of which contains an ink of a different color in order to perform three-color or four-color printing using a CMY model or a CMYK model, and wherein, in order to print said franking mark using a postal ink, the cyan ink reservoir is replaced with a reservoir of postal blue postal ink and/or the magenta ink reservoir is replaced with a reservoir of 185U red or fluorescent red postal ink.

3. A color printing method according to claim 2, wherein said print module is fed from three ink reservoirs, each of which contains an ink of a different color in order to perform three-color printing using a CMY model, and wherein the cyan ink reservoir is replaced with a reservoir of postal blue postal ink or the magenta ink reservoir is replaced with a reservoir of 185U red or fluorescent red postal ink.

4. A color printing method according to claim 2, wherein said print module is fed from three ink reservoirs, each of which contains an ink of a different color in order to perform three-color printing using a CMY.model, and wherein the cyan ink reservoir is replaced with a reservoir of postal blue postal ink and the magenta ink reservoir is replaced with a reservoir of 185U red or fluorescent red postal ink.

5. A color printing method according to claim 2, wherein said print module is fed from four ink reservoirs, each of which contains an ink of a different color in order to perform four-color printing using a CMYK model, and wherein the cyan ink reservoir is replaced with a reservoir of postal blue postal ink or the magenta ink reservoir is replaced with a reservoir of 185U red or fluorescent red postal ink.

6. A color printing method according to claim 2, wherein said print module is fed from four ink reservoirs, each of which contains an ink of a different color in order to perform four-color printing using a CMYK model, and wherein the cyan ink reservoir is replaced with a reservoir of postal blue postal ink and the magenta ink reservoir is replaced with a reservoir of 185U red or fluorescent red postal ink.

7. A color printing method according to claim 5, wherein said franking mark is printed with a combination of postal ink and of black ink in order to increase its contrast.

8. A color printing method according to claim 2, wherein said franking mark is printed with a combination of postal ink and of at least one of the remaining inks in order to obtain, once printed, the color components required by postal specifications.

9. A color printing method according to claim 2, wherein, with said mailpiece also including graphical elements or elements identifying the sender or third parties, which elements are associated with said franking mark, said elements are printed using a single ink other than the ink that enabled said franking mark to be printed.

10. A color printing method according to claim 2, wherein, with said mailpiece also including graphical elements or elements identifying the sender or third parties, which elements are associated with said franking mark, said elements are printed in a color obtained from at least two inks.

11. A print module fed from at least three ink reservoirs, each of which contains an ink of a different color, including at least one postal ink, said print module being suitable for implementing the color printing method according to claim 1.

12. A franking machine including a print module according to claim 11.

13. An envelope printer including a print module according to claim 11.
